(19) United States
(12) Patent Application Publication
(10) Pub. No.: US 2003/0140119 A1
(43) Pub. Date: Jul. 24, 2003

(54) Dynamic service discovery

(75) Inventors: Arup Acharya, Westwood, NJ (US); Stefan Berger, Ossining, NY (US); Young-Bae Ko, Wlmsford, NY (US); Nathan Junsup Lee, New City, NY (US); James Rubas, Yorktown Heights, NY (US)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/053,011

(22) Filed: Jan. 18, 2002

(51) Int. Cl. G06F 15/16

(52) U.S. Cl. 709/219

(57) ABSTRACT

The invention provides methods, apparatus and systems that allow devices to enter and leave a local domain often and still allow consumers of the service provided by the device to easily detect its availability. To achieve this, an example embodiment locates a “service discovery proxy” in the local domain. On receiving a service discovery request from a remote inquirer, the proxy resolves the service request based on those services that are determined to be dynamically available in the local domain at that time. The proxy resolves the incoming service request within its local domain by using any method for local service discovery. The response to the service discovery received from the local devices is customized by the service discovery proxy, wherein the customization includes formatting, filtering, aggregating, and/or selecting particular responses. The proxy then sends the customized response back to the remote inquirer.

### FIELD OF THE INVENTION

This invention is directed to the field of computer networking. It is more particularly directed to the detection of services available remotely and/or locally.

### BACKGROUND OF THE INVENTION

All pervasive devices will soon have the capability to communicate using the Internet Protocol (IP) and thus be connected to the Internet at large. Many of these pervasive connected devices will be the source of a specific service. In order to access the services in such a vast collection of devices, a centralized registry solution will prove to be impractical and costly. In addition, requiring device owners to register their mobile device or service with a central registry will likely be resisted. In the discussion that follows, we will explain a method that will enable service detection of remotely located devices without the inconvenience of requiring their registration at a central server.

A consumer of a service and the provider of the service need not be within local proximity of each other. Thus, it will often be the case that a service requester needs to discover services that are remotely available. A well known scheme for discovering remote services includes of the service providing device registering its service in a central service repository. In order for a remote device to make use of the service, it must inquire about the availability of the service with the central service repository using these steps:

(1) obtaining the IP address or the name of the device providing the service by means of a central service repository and, and

(2) connecting to the device to make use of the service.

Having an entry active in the central repository implies that the service is currently available. If the device providing the service either leaves the area or no longer chooses to provide the service, then it must initiate a de-registration action from the central repository. Otherwise, incorrect or stale data will reside in the central repository. This may additionally, cause the device requesting the service to time out while waiting for a response from the remote device actually providing the service. An example of a service that uses a central repository is the Domain Name Server (DNS). The service provided is the resolution of a host name into an IP address.

Considering the volume and dynamic nature of personal pervasive devices, the current centralized registry scheme is clearly undesirable. To find the service, a centralized registry scheme requires a link to that service, the maintenance of up-to-date service entries in the central repository and the processing of increased numbers of registration and de-registration messages.

Another scheme includes of inquiring for services within the local domain through the use of multicasting protocols. An example of this method is the Service Location Protocol (SLP). Typically multicasting protocols are not suitable for Internet wide queries and therefore the feasibility of such schemes are limited to local domains.

Definitions

Service: Performing a particular function for a requester.

Local Domain: A collection of devices are said to be in a local domain when the devices are within a same subnet relative to a proxy that services a request

Remote domain: A collection of devices that are located outside a local domain relative to a proxy that services a request.

Remote service: A service that is available to a requester, wherein said service resides in a domain other than the domain in which the requester resides.

Proxy: An apparatus that performs a function on behalf of other apparatus.

Dynamic availability. A service is said to have dynamic availability if it is currently available to provide a service to a requester.

Service Discovery Proxy: A Service Discovery Proxy is a proxy which dynamically resolves a service request based on services available in a local domain at the time the request is received.

### SUMMARY OF THE INVENTION

In order to overcome the problems described, the invention enables a local or remote service requester (requesting device) to communicate a request to a service domain proxy which will dynamically resolve the request among the currently available providers within its local domain. Mobile service providers entering or leaving the local domain of the proxy may announce or withdraw their services without requiring any recording entity.

It is therefore an aspect of the present invention to provide a method in which personal pervasive devices may enter and leave a local domain often and still allow consumers of their service to easily detect their availability. To achieve this, requester locates a proxy which can serve as a “Service Discovery Proxy” in the local domain. On receiving a service discovery request from a remote inquirer, the proxy resolves the service request based on those services that are determined to be dynamically available in the local domain at that time. The proxy resolves the incoming service request within its local domain by using available methods for local service discovery, such as Service Location Protocol (SLP). The proxy will then relay the response back to the remote inquirer either by aggregating the responses or by forwarding each response individually.

Other aspects and a better understanding of the invention may be realized by referring to the detailed description.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 shows an example of an environment having multiple network devices deployed in an IP network including of local and remote domains;

FIG. 2 shows a flowchart of a method used by an inquirer to query the central registry for the IP address of the proxy;

FIG. 3 shows a flowchart of a method used by the central registry to answer the inquirer's query for the IP address of the proxy.

FIG. 4 shows a flowchart of a method used by the inquirer to query the Service Discovery Proxy for available services;

FIG. 5 shows a flowchart of a method used by the Service Discovery Proxy to discover available services within its domain and forward the aggregated responses to the inquirer,

FIG. 6 shows a flowchart of a method used by the Service Discovery Proxy to discover available services within its domain and forward the individual responses to the inquirer; and

FIG. 7 shows the modules that comprise the Service Discovery Proxy.

### DESCRIPTION OF THE INVENTION

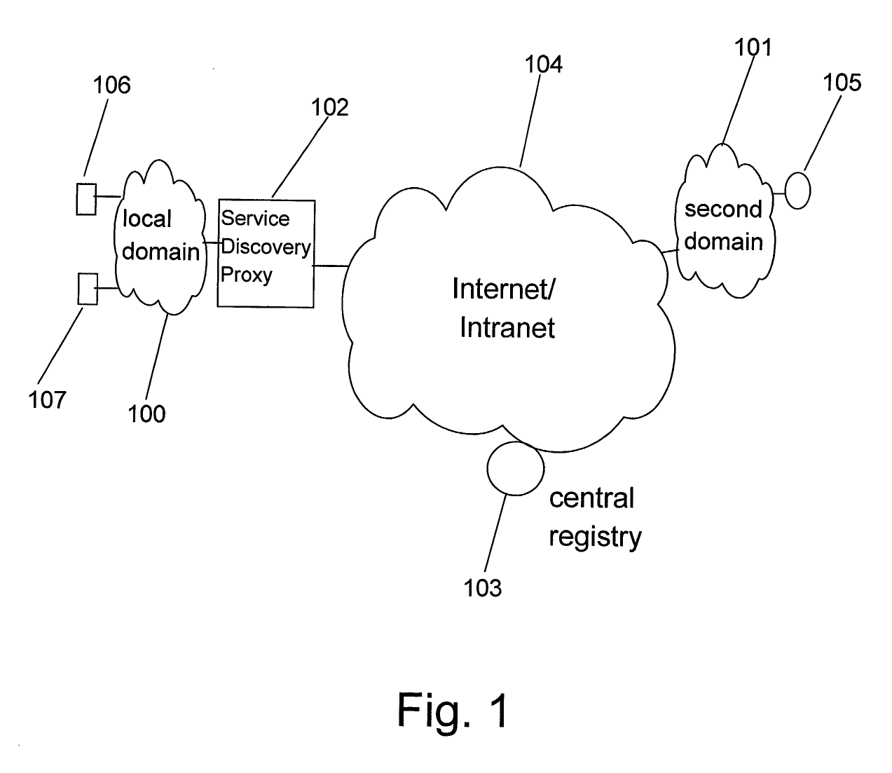

The present invention provides a means of discovering services remotely on mobile pervasive devices without requiring the registration of those devices with a central registration server. As shown in FIG. 1, in a computing network composed of multiple domains interconnected by Internet and/or Intranet, 104, a Service Discovery Proxy, 102, located in a local domain, 100, registers its service and location information in a known central registry, 103. An entity, 105, in a second domain, 101, that is interested in discovering services, 106, 107, in the local domain, 100, must local query the central registry, 103, to obtain network information for the Service Discovery Proxy, 102. Mobile pervasive devices such as 106 and 107 connect to the local domain 100 through possibly wired and/or wireless links. It is not necessary that the devices 106 and 107 be mobile or connected through a wireless link. They could also be wired devices which may not always be connected to the network. In either case, these devices offer some services that the inquiring entity 105 is interested to discover.

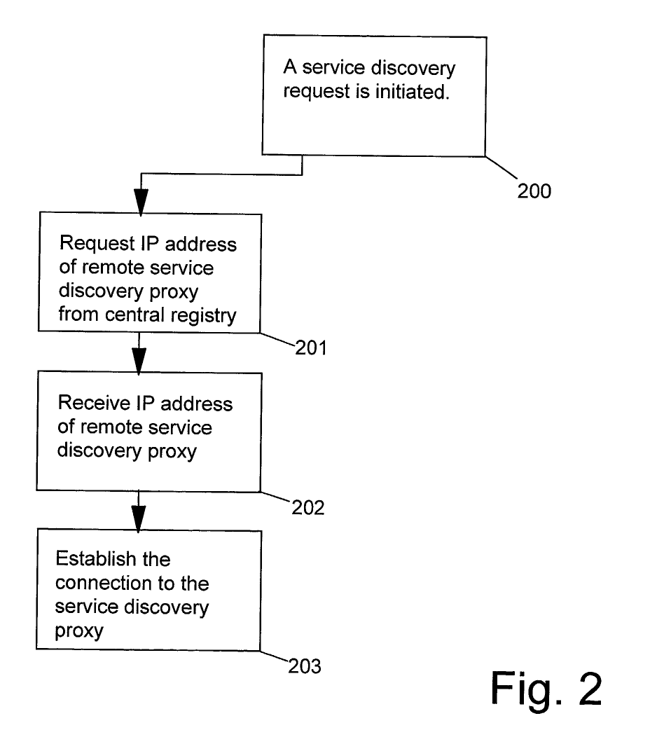

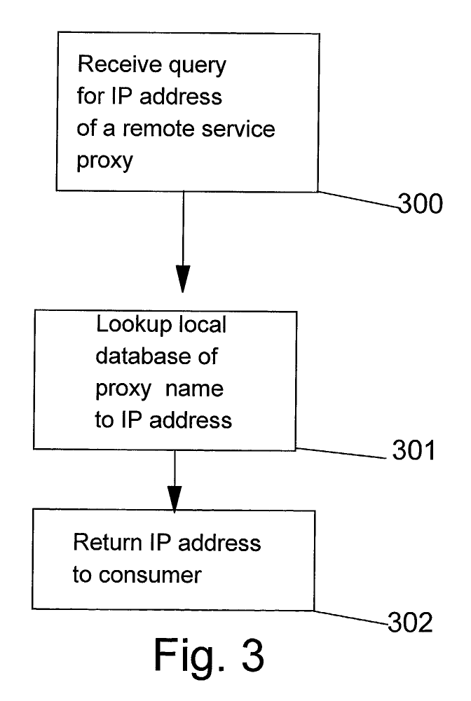

For an inquirer to invoke a remote service discovery, it needs to first discover the IP address of the remote proxy serving as a Service Discovery Proxy. This is done, as shown in FIG. 2, by sending a query 200 to a known central registry. The central registry resolves the request 201 and returns 202 the IP address of one or more proxies to the inquirer. The recipient then selects an address of a Service Discovery Proxy, 102, serving the local domain, 100. After that the connection to the Service Discovery Proxy can be established, 203 in accordance with any network/transmission protocol, such as TCP/IP. The central registry receives the request 300 as shown in FIG. 3. The central registry uses a local database 301 to resolve the name to IP address mapping. The central registry returns 302 the IP address to the inquirer.

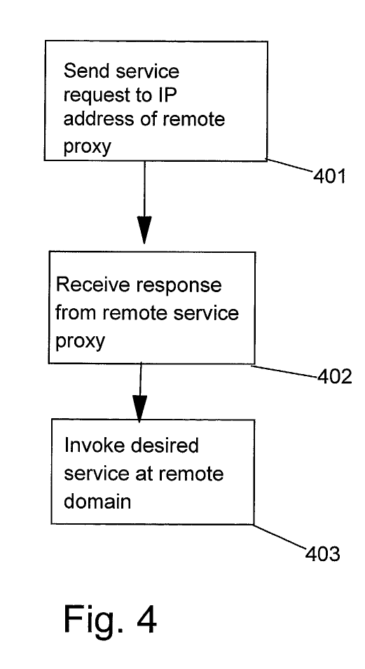

When the inquirer has the IP address of the remote proxy it can then send 401 the service request to the remote proxy as shown in FIG. 4. The inquirer receives a response 402 from the service request and then 403 invokes the desired service in the remote domain.

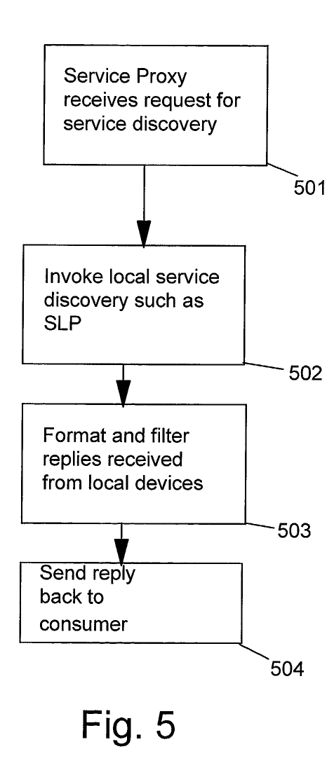

The Service Discovery Proxy is employed to discover the availability of at least one service in the local domain. This is accomplished by invoking a local service discovery protocol 502 such as SLP as shown in FIG. 5 after the Service Discovery Proxy received a request for service discovery 501. The inquirer may optionally request service discovery for only those services that are currently available and/or provide a list of services for which status information is requested. For subsequent requests, the list of services currently active in the local domain is dynamically updated without having to register any of the services with a central registry.

The response to the service discovery received from the local devices is customized 503, wherein the customizing includes formatting, filtering, aggregating, and/or selecting particular responses. Often but not necessarily, customization is generally performed in accordance with criteria given by said requester. The response is sent back 504 to the inquirer. The so discovered services may be utilized since the response information may include information enabling the requester to utilize the service.

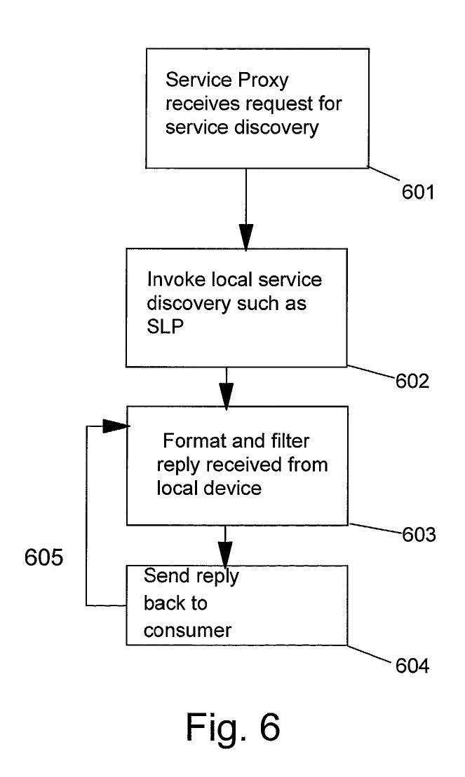

When the Service Discovery Proxy receives a request for service discovery 601 it invokes a local service discovery 602 such as SLP as shown in FIG. 6. The response to the service discovery received from the local device is formatted and filtered 603. The response is sent back 604 to the inquirer. The Service Discovery Proxy repeats response processing 605 for additional responses until all responses have been received. This proxy is responsible for discovering available services at the current time within its domain in response to a request from a remote user whose main role is to multicast the unicasted service request to the current set of devices in the local domain.

It is important to note that the proxy registration with a central registry such as DNS is much more acceptable, compared to the current remote service discovery schemes that require dynamic service providing devices to be dynamically registered and de-registered since the Service Discovery Proxy registration is for only one service and mostly static.

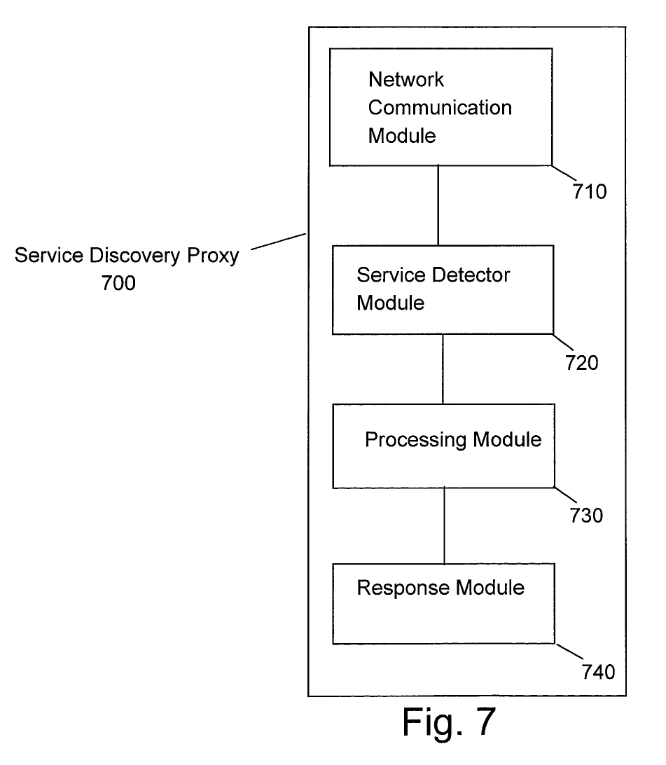

In an example embodiment, a Service Discovery Proxy 102, can be formed by assigning the proxy in representing a domain, establishing a connection between the proxy and a network, and then registering at least once its own service as a Service Discovery Proxy to a central registry. FIG. 7 shows a Service Discovery Proxy 700 employing modules formed in ways known to those familiar art. The Service Discovery Proxy includes a network communication module 710, and has been assigned a communication address. In order to allow said proxy to be accessed from a plurality of requesting devices that address should be known to a central registry. The Service Discovery Proxy also includes a service detector module 720, to detect services in the domain in which the proxy resides and a processing module 730, to process at least one incoming query from a requesting device regarding availability of at least one service. A responding module 740 in the Service Discovery Proxy is used to form outgoing responses to the query.

The network communication module of the Service Discovery Proxy establishes a listening port for incoming queries and communicates with a plurality of requesting devices with a transmission and network protocol such as TCP/IP. It may also obtain its own network communication address from the network address assigning entity and register the network communication address with the central registry as a Service Discovery Proxy, automatically.

The service detector module of the Service Discovery Proxy may support a plurality of physical communication media, link protocols, network protocols, transmission protocols, and service discovery protocols. It may also receive a service query from the processing module and determine appropriate communication protocol to be used. Its role also includes performing service discovery in accordance with selected service discovery protocol. Determining appropriate communication protocol involves multicasting service discovery packets over a plurality of network media using a plurality of communication protocols and determining appropriate protocol by evaluating response to the multicast

The processing module of the Service Discovery Proxy handles query of the availability of at least one service, all available services, and how to employ those services as well as interpreting the query and invoking the service detector module. The responding module of the Service Discovery Proxy transmits a query response to the requesting device and may also aggregate a plurality of query responses before transmitting to the requesting device.

It is noted that the present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after either or both of the following conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

The foregoing has outlined some of the more pertinent aspects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art

Having thus described our invention, what we claim as new and desire to secure by letters patent is as follows:

1. A method comprising a requester discovering at least one service in a local domain, including the steps of:
obtaining an address of a proxy serving as a Service Discovery Proxy for said local domain;
establishing a connection to said Service Discovery Proxy; and
employing said Service Discovery Proxy in discovering dynamic availability of said at least one service in said local domain.

2. A method as recited in claim 1, further comprising employing one service from said at least one service.

3. A method as recited in claim 1, wherein the step of obtaining includes:
contacting a central registry having addresses for a plurality of Service Discovery Proxies; and
selecting the address of a particular Service Discovery Proxy serving the local domain.

4. A method as recited in claim 1, wherein the step of establishing includes employing said address in accordance with a transmission protocol.

5. A method as recited in claim 4, wherein the transmission protocol is TCP/IP.

6. A method as recited in claim 1, wherein the step of employing includes querying said Service Discovery Proxy for a list of services currently active in said local domain.

7. A method as recited in claim 1, wherein said requester provides a list of services for which status is queried to said Service Discovery Proxy.

8. A method as recited in claim 7, further comprising dynamically updating the list of services currently active in said local domain without registering any of said services with a central registry.

9. A method as recited in claim 1, wherein the step of employing includes:
said Service Discovery Proxy receiving a request from said requester for service discovery;
said Service Discovery Proxy invoking a service discovery protocol in said local domain;
customizing responses from services in said local domain; and
said Service Discovery Proxy sending customized responses to said requester;

10. A method as recited in claim 9, wherein the step of customizing includes at least one function taken from a group of functions including: formatting; filtering; aggregating; encapsulating; segmenting; selecting, and a requester defined function.

11. A method as recited in claim 9, wherein the service discovery protocol includes Service Location Protocol.

12. A method as recited in claim 1, wherein the step of employing includes receiving information enabling said requester to utilize said at least one service.

13. A method comprising forming a Service Discovery Proxy including the steps of:
assigning an available proxy to represent a local domain;
establishing a connection between said available proxy and a network; and
registering said available proxy as the Service Discovery Proxy representing the local domain.

14. A method as recited in claim 13, wherein the step of registering is performed employing a central registry;

15. A Service Discovery Proxy comprising:
a network communication module having an assigned communication address,
a service detector module to detect dynamically available services in a local domain represented by said proxy;
a processing module to process at least one incoming query from a requester regarding availability of at least one service; and
a responding module to form outgoing responses to said at least one incoming query allowing discovery of any of said dynamically available services by sad requester.

16. A proxy as recited in claim 15, wherein said communication address exists in a central registry to allow said proxy to be accessed from a plurality of requesters.

17. A proxy as recited in claim 15, wherein said network communication module further:
establishes a listening port for incoming queries; and
communicates with a plurality of requesters with a transmission protocol.

18. A proxy as recited in claim 15, wherein said network communication module obtains an assigned network communication address from a network address assigning entity; and
registers said assigned network communication address with a central registry as a Service Discovery Proxy;

19. A proxy as recited in claim 15, wherein said service detector module supports at least one communications functionality from a group of functionalities including:
at least one physical communication media;
at least one link protocol;
at least one network protocol;
at least one transmission protocol;
at least one service discovery protocol;
receiving service queries from said processing module;
determining an appropriate communication protocol to be used;
performing service discovery in accordance with a selected service discovery protocol; and
any combination of these.

20. A proxy as recited in claim 15, wherein said service detector module determines an appropriate communication protocol to use.

21. A proxy as recited in claim 15, wherein said processing module performs a function taken from a group of functions including:
querying the availability of at least one service;
querying all available services;
querying the employment of said service;
interpreting said query and invoking service detector module; and
any combination of these.

22. A proxy as recited in claim 15, wherein said responding module transmits said query response to the requester.

23. A proxy as recited in claim 15, wherein said responding module aggregates a plurality of query responses before transmitting a particular response to the requester.

24. An article of manufacture comprising a computer usable medium having computer readable program code means embodied therein for causing requester discovery of a service, the computer
readable program code means in said article of manufacture comprising computer readable program code means for causing a computer to effect the steps of claim 1.

25. A program storage device readable by machine, tangibly embodying a program of instructions executable by the machine to perform method steps for requester service discovery, said method steps comprising the steps of claim 1.

27. A computer program product comprising a computer usable medium having computer readable program code means embodied therein for causing functions of a Service Discovery Proxy, the computer readable program code means in said computer program product comprising computer readable program code means for causing a computer to effect the functions of claim 15.
